(19) United States
(12) Patent Application Publication
(10) Pub. No.: US 2015/0001191 A1
(43) Pub. Date: Jan. 1, 2015

(54) METHOD FOR MANUFACTURING METAL NANOPOWDER BY WIRE-EXPLOSION AND APPARATUS FOR MANUFACTURING THE SAME

(71) Applicant: SAMSUNG ELECTRO-MECHANICS CO., LTD., Suwon (KR)

(72) Inventors: Sung Ho LEE, Suwon (KR); Jung Wook SEO, Suwon (KR)

(73) Assignee: SAMSUNG ELECTRO-MECHANICS CO., LTD., Suwon (KR)

(21) Appl. No.: 14/027,457

(22) Filed: Sep. 16, 2013

(30) Foreign Application Priority Data
Jun. 28, 2013 (KR) 10-2013-0076065

(51) Int. Cl. B01J 19/08

(52) U.S. Cl. CPC B01J 19/088; Y10S 977/777; B82Y 40/00
USPC 219/121.11; 977/777

(57) ABSTRACT

There is provided a method for manufacturing a metal nanopowder having a uniform particle size distribution by uniformly applying current to the entirety of a metal raw material, while reducing energy usage, and an apparatus for manufacturing the same. The method includes disposing a metal foil in a reaction chamber; supplying direct current (DC) energy to the metal foil disposed in the reaction chamber; and supplying pulse energy to the metal foil to which the DC energy is supplied, thereby wire-exploding the metal foil.

### CROSS-REFERENCE TO RELATED APPLICATION

This application claims the priority of Korean Patent Application No. 10-2013-0076065 filed on Jun. 28, 2013, with the Korean Intellectual Property Office, the disclosure of which is incorporated herein by reference.

### BACKGROUND OF THE INVENTION

1. Field of the Invention

The present invention relates to a method for manufacturing a metal nanopowder by wire-explosion and an apparatus for manufacturing the same, and more particularly, to a method for manufacturing a nanopowder having a uniform particle size distribution by uniformly applying electrical energy to a metal raw material, and an apparatus for manufacturing the same.

2. Description of the Related Art

Technology has moved in a direction in which devices and components are small-sized, lightweight, and have high strength, due to industrial improvements. One method capable of satisfying the functions is to manufacture a device and a component using nanoparticles.

In general, nanoparticles have a diameter of 1 nm to 100 nm, and even in the case that a material formed of the nanoparticles has the same chemical composition and the same physical crystallization structure, the material formed of nanoparticles may have specific physical properties which are not evident in an existing material.

Nanoparticles have great industrial potential in fields such as the field of electronic components, the field of materials of living, the field of medicine, the field of national defense, the field of energy generation, the field of environmental materials, and the like, due to the specific physical properties thereof, and as certain nanoparticles have been commercialized, their value has been confirmed.

Unlike the positive aspects as described above, nanoparticles have problems to which solutions are sought, and for example, nanoparticles may have difficulties in terms of dispersibility due to having a large specific surface area, difficulties in terms of chemical stability regarding particle oxidation, and difficulties in terms of obtaining nanoparticles having a uniform size in a manufacturing process thereof.

As a method for synthesizing nanoparticles, a chemical synthesis method is mainly used. However, in consideration of industrial improvements and environmental aspects such as global warming, the chemical synthesis method has disadvantages in that contamination caused by impurities, the generation of chemical by-products such as waste solutions, dangers in handling chemical materials, and the like may occur.

Therefore, systems which are environmentally friendly and are capable of mass producing a nanopowder by using a vapor method have been studied and developed, and as a method having a high possibility for enabling mass-production, physical methods such as a plasma heating method, a pulsed wire discharge (PWD) method, and the like, may be used.

The pulsed wire discharge (PWD) method is a method in which, after a capacitor is charged with current, a power pulse is produced using high voltage to instantaneously discharge electrical energy into a metal wire, such that the metal is evaporated and condensed to produce the nanopowder. A flowchart in which wire in a solid-phase is vaporized to form the nanopowder is illustrated in FIG. 1.

The pulsed wire discharge (PWD) method may be utilized for use with all metals and alloys capable of being formed into wire, and may be easily used in producing oxides and nitrides by using oxygen or nitrogen in the atmosphere of the process. In general, the discharge process takes 10⁻⁶ seconds, and 10⁶ W of power is consumed during this short period of time. The pulsed wire discharge (PWD) method is appropriate for producing nanopowder particles having a size of 50 nm to 150 nm.

However, in the pulsed wire discharge (PWD) method according to the related art, a nanopowder having a particle size distribution of several nm is produced on a surface portion of the metal wire, but a nanopowder having a particle size distribution of several μm is produced in the center portion thereof.

The reason that nanoparticles having a non-uniform particle size distribution are produced is because an electric field flowing through the wire is not constant. In wire having a smooth surface, the extent of disturbance with respect to current flow is different between the surface portion of the metal wire and the center portion thereof due to a skin effect, such that the surface portion thereof is initially exploded and the center portion is subsequently exploded. Here, the evaporation in the center portion is not smooth, such that it may be difficult to produce nanopowder particles, and therefore, relatively large micro-sized particles are produced. The reason for this is that the current flow is small in the center portion of the metal wire, such that Joule heating is also low.

FIG. 2 is a view illustrating a process in which a nanopowder is manufactured due to wire-explosion of a metal wire. As illustrated in FIG. 2, since a constant electric field is not applied to a metal wire, evaporation is initiated from a surface of the metal wire, energy is deficient and Joule heating is insufficient in a center portion of the metal wire, such that large particles are produced or a liquid-phase occurring before evaporation is maintained, thereby causing negative effects in the nanopowder. Similar to this, a relatively large powder particle may be easily manufactured due to contact resistance, even in an electrode portion.

In addition, the manufactured nanopowder having the non-uniform particle size distribution requires filtering having a high resolution and a sorting process using centrifugal force in the subsequent process, such that the process may be complicated and costs increased.

Therefore, a method for synthesizing a nanopowder having a uniform particle size distribution by uniformly supplying electrical energy to a metal raw material in the pulsed wire discharge (PWD) method has been demanded.

Patent Document 1, which is directed to an apparatus for the production of a metal nanopowder by wire-explosion, is characterized by mounting a vibrator on a feeding unit to allow a particle size of a nanopowder produced according to a position of a wire to be uniform, through a mechanical resonance phenomenon and vibration of atoms and electrons.

### RELATED ART DOCUMENT

(Patent Document 1) Korean Patent Laid-Open Publication No. 10-2011-0122277

### SUMMARY OF THE INVENTION

An aspect of the present invention provides a method for manufacturing a metal nanopowder having uniform particle size distribution by wire-explosion by uniformly applying current to a metal raw material, and an apparatus for manufacturing the same.

According to an aspect of the present invention, there is provided a method for manufacturing a metal nanopowder by wire-explosion, the method including: disposing a metal in a reaction chamber, the metal being provided in the form of a foil (a metal foil); supplying direct current (DC) energy to the metal foil disposed in the reaction chamber; and supplying pulse energy to the metal foil to which the DC energy is supplied, thereby wire-exploding the metal foil.

The metal foil may have a thickness of 0.001 mm to 1 mm.

The metal foil may be wound around an electrode rod, such that the electrode rod and the metal foil may be disposed together.

The pulse energy may be supplied at an interval of 0.5 to 10 seconds in a state in which the DC energy is supplied to the metal foil.

The DC energy and the pulse energy may be applied to the metal foil at a voltage ratio of 9:1 to 9.99:0.01.

The DC energy may be supplied by applying a voltage of 0.9 kV to 90 kV to the metal foil, and the pulse energy may be supplied by applying a voltage of 0.1 kV to 10 kV to the metal foil.

The metal foil may include at least one selected from the group consisting of copper, nickel, aluminum, iron, gold, and silver.

According to another aspect of the present invention, there is provided an apparatus for manufacturing a metal nanopowder by wire-explosion, the apparatus including: a reaction chamber in which a metal is wire-exploded to manufacture a nanopowder; a feeding unit provided in an upper portion of the reaction chamber and supplying an electrode rod having a metal foil wound therearound to the reaction chamber; a power supplying unit supplying electrical energy to the electrode rod having the metal foil wound therearound and disposed in the reaction chamber by the feeding unit; and a transferring unit provided in the reaction chamber and transferring the electrode rod mounted thereon to the power supplying unit, the electrode rod having the metal foil wound therearound and supplied from the feeding unit.

The power supplying unit may include a DC voltage supplying part and a pulse voltage supplying part.

The transferring unit may include: a lower support supporting the electrode rod having the metal foil wound therearound and supplied from the feeding unit; an upper support mounted on the electrode rod having the metal foil wound therearound; and a transfer element transferring the upper support and the lower support in a direction toward the power supplying unit.

The feeding unit may have a plurality of electrode rods mounted therein, each electrode rod having the metal foil wound therearound, and may successively supply the plurality of electrode rods to the transferring unit while being rotated.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart illustrating a process of manufacturing a nanopowder by wire-explosion;

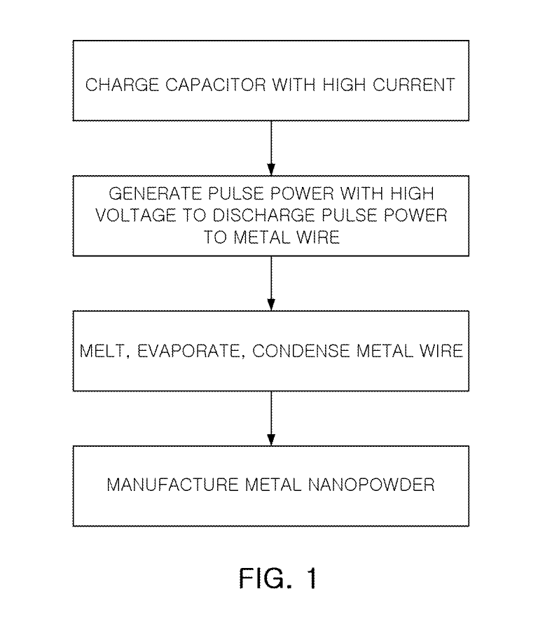

FIG. 2 is a view illustrating a process in which a nanopowder is manufactured due to wire-explosion of a metal wire;

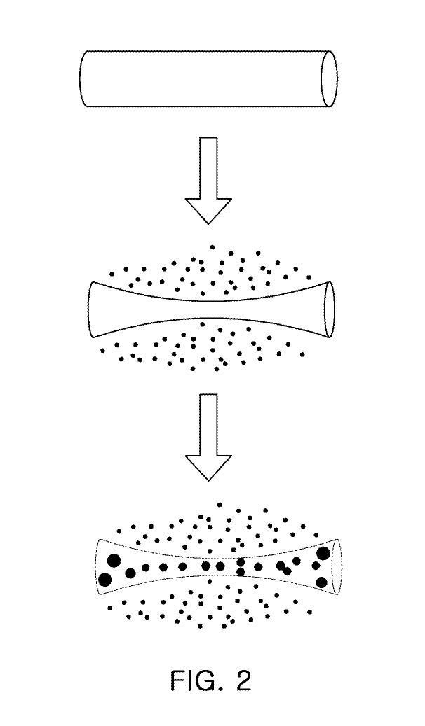

FIG. 3 is a view illustrating an apparatus for manufacturing a metal nanopowder by wire-explosion according to an embodiment of the present invention; and

FIG. 4 is an enlarged view of a feeding unit provided in the apparatus for manufacturing a metal nanopowder by wire-explosion according to the embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

When a metal nanopowder is manufactured using a wire-explosion method, a metal is provided in the form of a foil in an embodiment of the present invention in order to allow a flow of current to be uniform within the metal raw material. Since the metal foil having a large area has the current uniformly applied thereto, a metal nanopowder having a uniform particle size distribution may be manufactured.

In addition, in the case of the metal foil, direct current (DC) energy may be supplied and pulse energy may be simultaneously supplied as a portion of the energy to wire-explode the metal foil, such that the metal nanopowder may be manufactured using a significantly reduced amount of energy.

More specifically, a method for manufacturing a metal nanopowder by wire-explosion according to an embodiment of the present invention may include supplying a metal in the form of a foil (metal foil) to a reaction chamber; supplying direct current (DC) energy having a high voltage to the metal foil disposed in the reaction chamber; and supplying pulse energy to the metal foil to which the DC energy is supplied, thereby wire-exploding the metal foil.

First, the supplying of the metal foil to the reaction chamber will be described.

The metal raw material is not specifically limited as long as it can be provided in the form of a foil, and for example, copper, nickel, aluminum, iron, gold, or silver, or an alloy or mixture thereof may be used.

A thickness of the metal foil may be 0.001 mm to 1 mm. In the case in which the thickness of the metal foil is less than 0.001 mm, it may be difficult to feed the metal foil, and in the case in which the thickness of the metal foil is greater than 1 mm, a difference in current flow according to a position of the metal foil may be generated.

In order to supply the metal foil to the reaction chamber in which the wire-explosion occurs, the metal foil may be wound around an electrode rod, such that the electrode rod and the metal foil may be disposed together. A shape of the electrode rod is not specifically limited, but for example, the electrode rod may have a cylindrical shape or a polygonal pillar shape. A diameter of the electrode rod may be 1 mm to 10 mm, and a length thereof may be 1 mm to 100 mm.

Then, the electrode rod may be used to supply the DC energy having high voltage to the metal foil and the pulse energy may be supplied to the metal foil to which the DC energy is supplied, such that the metal foil is wire-exploded.

In the case in which the metal foil is supplied, a portion of the energy required for evaporating the metal foil may be supplied in the formed of DC energy. The pulse energy may be temporarily supplied to the metal foil in a state in which the DC energy is continuously supplied to the metal foil, thereby wire-exploding the metal foil to manufacture a nanopowder. In the case in which the metal raw material is provided in the form of the foil, while the portion of the required energy is supplied as the DC energy, a significantly small amount of pulse energy may only be used to wire-explode the metal foil. Therefore, a relatively small amount of energy may be used to manufacture a large amount of nanopowder, such that energy usage may be reduced.

The DC energy and the pulse energy supplied as described above may be applied at a voltage ratio of 9:1 to 9.99:0.01 with respect to an overall voltage required for wire-explosion. In the case in which the pulse voltage is greater than the range of the voltage ratio, it may be difficult to perform a continuous circuit operation, and in the case in which the pulse voltage is less than the range of the voltage ratio, ignition may not instantaneously succeed, such that it may be difficult to wire-explore the metal foil.

More specifically, the wire-explosion may occur by periodically supplying a pulse voltage of 0.1 kV to 10 kV in a state of continuously supplying a DC voltage of 0.9 kV to 90 kV, and the supplied voltages may be constant in the above-described ranges or may be changed.

Here, the pulse voltage may be supplied at an interval of 0.5 to 10 seconds in a state in which the DC energy is supplied to the metal foil, and the period may be constant in the above-described range or may be changed.

As described above, the metal raw material is supplied in the form of a foil rather than the formed of a wire, and the pulse energy is periodically and simultaneously supplied in the state in which the DC energy is supplied to the metal foil, such that a uniform current flow may be generated throughout the metal foil to manufacture a nanopowder having a uniform particle size distribution and to reduce energy usage.

Then, an apparatus for manufacturing a metal nanopowder by wire-explosion according to an embodiment of the present invention will be described.

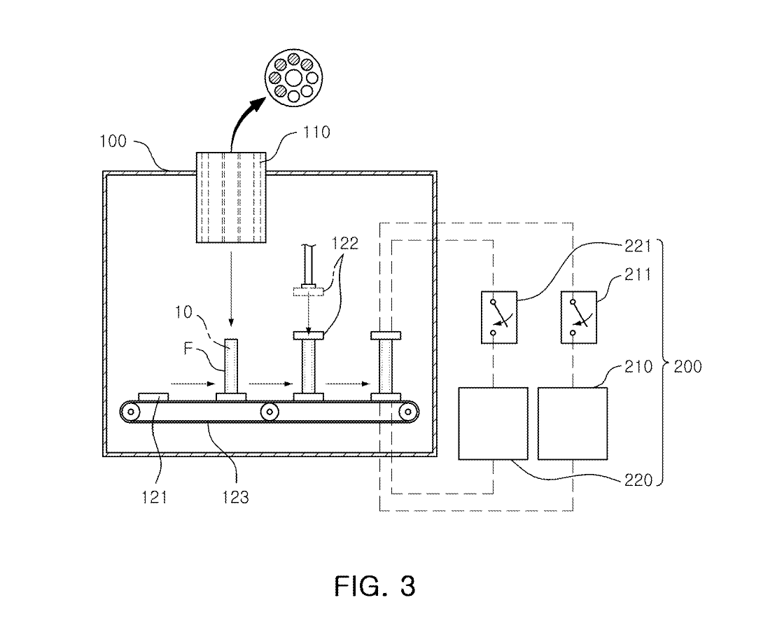

FIG. 3 is a view illustrating an apparatus for manufacturing a metal nanopowder by wire-explosion according to an embodiment of the present invention.

Referring to FIG. 3, a reaction chamber 100 in which wire-explosion occurs may include a feeding unit 110 provided in an upper portion thereof, the feeding unit 110 supplying an electrode rod 10 having a metal foil F wound therearound. The electrode rod 10 supplied from the feeding unit 110 and having the metal foil F wound therearound may be transferred in a direction toward a power supplying unit 200 by a transferring unit 121, 122 and 123. DC voltage and pulse voltage may be supplied to the transferred electrode rod 10 having the metal foil F wound therearound by the power supplying unit 200 and the metal foil F may be wire-exploded to manufacture a nanopowder.

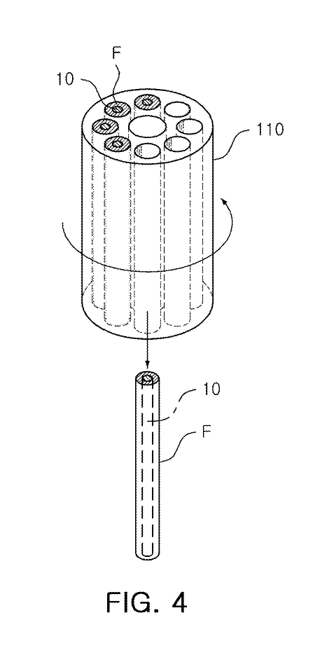

As illustrated in FIG. 4, the feeding unit 110 may have a plurality of electrode rods 10 mounted therein, each electrode rod having the metal foil F wound therearound and successively drop the electrode rods 10 while the feeding unit 110 is rotated, such that the electrode rod 10 having the metal foil F wound therearound may be mounted on a lower support 121.

The electrode rod 10 having the metal foil F wound therearound and mounted on the lower support may be transferred, such that an upper support 122 may be mounted on the electrode rod 10. The electrode rod 10 having the metal foil F wound therearound and mounted between the lower support 121 and the upper support 122 may be transferred to be connected to the power supplying unit 200 by a transfer element 123.

The power supplying unit 200 may include a DC voltage supplying part 210 and a pulse voltage supplying part 220, each of which may be provided with switches 211 and 221 controlling a connection to the electrode rod 10. In a state in which the DC voltage is continuously supplied by the DC voltage supplying part 210, the pulse voltage may be temporarily supplied by the pulse voltage supplying part 220, thereby causing the wire-explosion.

In an electric wire of the pulse voltage supplying part 220 connected to the electrode rod 10, a distal end of the electric wire facing the electrode rod 10 may not be directly connected to the electrode rod 10, but may be spaced apart from the electrode rod 10. Since the pulse voltage supplying part 220 is only required to supply the pulse voltage for causing wire-explosion by ignition in the state in which the DC voltage is applied to the electrode rod, it may be spaced apart from the electrode rod 10 by 5 mm to 50 mm.

As set forth above, in a method and an apparatus for manufacturing a metal nanopowder by wire-explosion according to embodiments of the invention, a metal raw material provided in the form of a foil (metal foil) and having a large area is used instead of a metal wire, such that current may be uniformly applied to the entirety of the metal foil, whereby a nanopowder having a uniform particle size distribution can be manufactured.

In addition, direct current (DC) energy is supplied to the metal foil and pulse energy is simultaneously supplied thereto, such that energy usage may be reduced.

While the present invention has been shown and described in connection with the embodiments, it will be apparent to those skilled in the art that modifications and variations can be made without departing from the spirit and scope of the invention as defined by the appended claims.

What is claimed is:

1. A method for manufacturing a metal nanopowder by wire-explosion, the method comprising:
disposing a metal in a reaction chamber, the metal being provided in the form of a foil (a metal foil);
supplying direct current (DC) energy to the metal foil disposed in the reaction chamber; and
supplying pulse energy to the metal foil to which the DC energy is supplied, thereby wire-exploding the metal foil.

2. The method of claim 1, wherein the metal foil has a thickness of 0.001 mm to 1 mm.

3. The method of claim 1, wherein the metal foil is wound around an electrode rod, such that the electrode rod and the metal foil are disposed together.

4. The method of claim 1, wherein the pulse energy is supplied at an interval of 0.5 to 10 seconds in a state in which the DC energy is supplied to the metal foil.

5. The method of claim 1, wherein the DC energy and the pulse energy are applied to the metal foil at a voltage ratio of 9:1 to 9.99:0.01.

6. The method of claim 1, wherein the metal foil includes at least one selected from the group consisting of copper, nickel, aluminum, iron, gold, and silver.

7. The method of claim 1, wherein the DC energy is supplied by applying a voltage of 0.9 kV to 90 kV to the metal foil, and
the pulse energy is supplied by applying a voltage of 0.1 kV to 10 kV to the metal foil.

8. An apparatus for manufacturing a metal nanopowder by wire-explosion, the apparatus comprising:
a reaction chamber in which a metal is wire-exploded to manufacture a nanopowder;
a feeding unit provided in an upper portion of the reaction chamber and supplying an electrode rod having a metal foil wound therearound to the reaction chamber;
a power supplying unit supplying electrical energy to the electrode rod having the metal foil wound therearound and disposed in the reaction chamber by the feeding unit; and
a transferring unit provided in the reaction chamber and transferring the electrode rod mounted thereon to the power supplying unit, the electrode rod having the metal foil wound therearound and supplied from the feeding unit.

9. The apparatus of claim 8, wherein the power supplying unit includes a DC voltage supplying part and a pulse voltage supplying part.

10. The apparatus of claim 8, wherein the transferring unit includes:
a lower support supporting the electrode rod having the metal foil wound therearound and supplied from the feeding unit;
an upper support mounted on the electrode rod having the metal foil wound therearound; and
a transfer element transferring the upper support and the lower support in a direction toward the power supplying unit.

11. The apparatus of claim 8, wherein the feeding unit has a plurality of electrode rods mounted therein, each electrode rod having the metal foil wound therearound, and successively supplies the plurality of electrode rods to the transferring unit while being rotated.
